(19) United States
(12) Patent Application Publication
(10) Pub. No.: US 2007/0161539 A1
(43) Pub. Date: Jul. 12, 2007

(54) Method of regulating degree of polymerization of an alkali metal silicate in solution using pH

(76) Inventor: Enrique Hernandez, Brownsville, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/330,447

(22) Filed: Jan. 12, 2006

(51) Int. Cl. C11D 3/02

(52) U.S. Cl. 510/511

(57) ABSTRACT

The present disclosure relates to alkali metal silicates. Methods for regulating the degree of polymerization of an alkali metal silicate in solution using pH are provided. The degree of polymerization may be regulated to be less than or equal to about 2.5. Methods for cleaning by contacting a surface with an alkali metal silicate solution having a pH-regulated degree of polymerization are also provided.

### TECHNICAL FIELD

The present disclosure, according to one embodiment, relates to methods of regulating the degree of polymerization of an alkali metal silicate in solution using pH. It also relates to an alkali metal silicate solution having a pH-regulated degree of polymerization. It also relates to using pH to cause a low degree of polymerization in an alkali metal silicate. This disclosure also relates to formation of a cleaning product containing an alkali metal silicate solution with a degree of polymerization regulated using pH.

### BACKGROUND

Cleaning products may be grouped into four general categories: personal cleansing, laundry, dishwashing, and household cleaning. Within each category are different product types formulated with ingredients selected to perform a broad cleaning function as well as to deliver properties specific to that product. Cleaning products generally include a surfactant and a builder.

Surfactants are organic chemicals that change the properties of water. By lowering the surface tension of water, surfactants enable the cleaning solution to wet a surface (e.g., clothes, dishes, countertops) more quickly, so soil can be readily loosened and removed (usually with the aid of mechanical action). Surfactants also emulsify oily soils and keep them dispersed and suspended so they do not settle back on the surface.

There are different types of builders and, sometimes more than one type of molecule is involved to form a “builder system.” Builders function in several ways. They increase the alkalinity of the wash solution, which helps the surfactant activity and also helps to emulsify fats and oils in the soiled fabrics. They also help to “break” clay-types of dirt from fabrics, and combine with them to help prevent redeposition on fabrics. They also function to combine with hard water mineral ions, thus “softening” the water.

Softening water may prevent water hardness ions from reacting with other detergent ingredients, which could cause them to work less efficiently or precipitate from solution. Water hardness ions can form insoluble salts, which may become encrusted in fabrics and deposited on solid surfaces inside a washing machine. In this way, builders extend the life of the washing machine. Additionally, soil molecules are often bound to fabric surfaces by calcium ion bridging; removal of calcium ions therefore may help stain removal.

The primary function of builders is to reduce water hardness (e.g., Ca²+and Mg²+). This can be done either by sequestration or chelation, by precipitation, or by ion exchange. Thus, builders are often divided into three general categories: (1) sequestrating/chelating builders, which are soluble builders and form soluble complexes with cations; (2) ion exchange builders, which are insoluble builders and form insoluble complexes with cations; and (3) precipitating builders, which are soluble builders and form insoluble complexes with cations. Complex phosphates and sodium citrate are common sequestering builders. Sodium carbonate and sodium silicate are precipitating builders. Sodium aluminosilicate (zeolite) is an ion exchange builder.

Sequestrating builders disperse and suspend dirt. In aqueous solutions, these compounds combine with metal ions, like calcium, to substantially inactivate the ion. Some sequestrating builders, like STPP, form complexes with mineral ions, which stay in solution and may be rinsed away. Over time and with exposure to water, STPP will decompose into a mono-phosphate, or “orthophosphate,” called trisodiumphosphate (“TSP”). TSP is often used for cleaning hard surfaces where a precipitate is not a problem, but due to its precipitate formation is not favored for laundry use, as the precipitate often forms a white film on fabrics. Moreover, the use of phosphate builders is limited or banned in many U.S. states, as well as in much of Europe because of eutrophication. In Europe, and increasingly in the USA, compounds such as zeolites (aluminum silicates) and phosphonates (a form of phosphate not thought to promote eutrophication) are being used as substitutes for complex phosphates in laundry detergents.

Ion exchange builders include zeolites. Zeolites are synthetic sodium aluminum silicates that are used in detergents (among other applications) for their cation-exchanging capacity. Most modern laundry detergent powders and tablets that do not contain phosphates, contain zeolites. Zeolites replace the water hardness ions (e.g., Ca²⁺ and Mg²⁺) with Na⁺ ions. Zeolites, like clays, are insoluble in water and are present in the wash as finely dispersed crystals (with a diameter of ˜4 microns). Zeolite builders are expensive, non-soluble in aqueous liquids, and suffer from poor performance.

Common precipitating builders include sodium carbonate (soda ash or Na₂CO₃) and silicates. Precipitating builders generally have high alkalinity and are good for “breaking” soil from fabric, but often forms an insoluble compound with hard water mineral ions, and also with mineral ions in the soil they release from fabrics. The insoluble compounds that are formed may redeposit on fabrics and washer parts. On fabrics it can look like white lint or powder. On washer parts, it can form a rock-like scale which can be harmful to the washer mechanisms.

### SUMMARY

The present disclosure relates to alkali metal silicates. According to one embodiment, a method for regulating the degree of polymerization of an alkali metal silicate in solution is provided. The method may include forming a solution of an alkali metal silicate and regulating the pH of the solution to be approximately a selected pH. The selected pH may result in a desired degree of polymerization of the alkali metal silicate in the solution.

According to another embodiment, a method for making an alkali metal silicate solution is provided. The method may include providing a solution of an alkali metal silicate characterized by a degree of polymerization greater than about 2.5, and adjusting the pH the solution to a level sufficient to at least partially shift the degree of polymerization of the alkali metal silicate to a level less than or equal to about 2.5.

According to a third embodiment, a method for cleaning is provided. The method may include contacting a surface with a solution comprising an alkali metal silicate having a degree of polymerization less than or equal to about 2.5. The solution may have a pH selected to regulate the degree of polymerization of the alkali metal silicate.

### DESCRIPTION

The present disclosure, according to one embodiment, provides a method of regulating the degree of polymerization of an alkali metal silicate using pH. It also provides an alkali metal silicate solution having a pH-regulated degree of polymerization. According to a more specific embodiment, the degree of polymerization may be regulated using pH to be less than or equal to about 2.5. The solution may be an aqueous or other liquid solution. The solution may then include silicate anions of various distributions. Various factors may affect the properties of the silicate solution. One such factor may be the anionic species distribution (i.e., silicate speciation). Another factor may be pH.

The silicate ions present in the solution formed may exist as an equilibrium of monomeric and polymeric species. In solution, polymeric silicate species are known to form porous film deposits that appear white and opaque when dried, which is generally not a desirable form of deposition on fabrics or metals. In contrast, alkali metal silicate solutions in which monomeric silicate species may predominate, may form non-porous and clear deposits. As a result, solutions with primarily monomeric species may be more useful in many applications, such as cleaning applications in which a visible film is undesirable.

The concentrations of monomer and polymer in the equilibrium depend in part on the silica content and the SiO₂:Na₂O ratio of the solution. The monomeric species include silicon oxides that are not bonded to any other silicon atoms (e.g., SiO₄⁴⁻). Structurally, a monomeric silicon oxide may be represented as a tetrahedral anion with a silicon atom at the center of an oxygen-cornered, four sided pyramid. Other atoms may be associated with these oxygen atoms, such as hydrogen, sodium, or potassium. The oxygen atom of the silicon oxide monomer may be linked to other silicon atoms through tetrahedral coordination. In this way other, “polymerized” forms of silicon oxide anions may be formed. In polymeric forms of silicon oxides, the silicon atom of a monomer may be linked to between one and four other silicon atoms through a shared oxygen, which ultimately may form two- and three-dimensional structures.

A shorthand for representing the monomeric and polymeric species in a silicate solution uses the ratio of silicon dioxide to a alkali-metal oxide as follows: xSiO₂:M₂O, in which “M” is an alkali metal (e.g., sodium (Na) or potassium (K)) and “x” represents the weight ratio of silica to alkali-metal oxide. At ratios greater than about 2.0, polymer species begin to form as solids in the solution. Table 1 shows how the SiO₂:Na₂O ratio affects the degree of polymerization of an sodium silicate solution. See Nauman & Debye, J. Phys. Chem. 55:1 (1951).

TABLE 1

| SiO₂:Na₂O | Degree of | Molecular |
|---|---|---|
| Ratio | polymerization | weight |
| 0.48 | — | 60 |
| 1.01 | — | 70 |
| 2.0 | 2.5 | 150 |
| 2.2 | 3 | 180 |
| 2.6 | 7 | 420 |
| 3.1 | 15 | 900 |
| 4.0 | 27 | 1600 |

As mentioned above, the concentrations of monomer and polymer also depend in part on the silica content of the solution. Thus, for example, adding a silica source (e.g., colloidal silicate) to a high-ratio silicate solution may increase the SiO₂:Na₂O ratio, thereby forming more polymeric species. In general, as concentrated alkali metal silicate solutions are diluted (to a lower limit of 330 ppm), the pH and OH⁻ concentration are reduced, and silicate ions hydrolyze to form larger polymeric species and silicates with a lower SiO₂:Na₂O ratio. See R. K. Iler, The Chemistry of Silica, John Wiley and Sons, New York (1979). Solutions of soluble silicates are generally highly alkaline. When such highly alkaline soluble silicate solutions are neutralized by acid to a pH below about 10.7, the silicate ions decompose to silicic acid [Si(OH)₄], which then may polymerize to silica. For very dilute solutions (<˜300 ppm SiO₂), however, essentially complete depolymerization occurs and monomer (i.e., Si(OH)₄ and HSiO₃⁻) is the dominant species. Monomeric species are better able to sequester cations (e.g., calcium cations) than polymeric species. The presence of the monomeric species may be measured using molybdic acid reagent as described in G. B. Alexander, “The Reaction of Low Molecular Weight Silicic Acids with Molybdic Acid” J. Am. Chem. Soc. 75:5655-7 (1953).

While silica content of the solution affects the degree of polymerization, the distribution of monomer and polymer species in an alkaline metal silicate solution also may vary based on changes in the solution's chemical environment. pH represents a significant property of the chemical environment. As pH of the solution decreases, the degree of polymerization increases. This affects various properties of the alkali metal silicate in solution. For example, as the degree of polymerization increases the water-softening ability of the alkali metal silicate decreases. Monomeric species, such as SiO₃²⁻, predominate at pHs above about 13. Polymeric species may form at pHs below about 13 and 11, with SiO₂O₅²⁻ as the principle ion. Colloidal particles predominate at pHs below about 9. Thus, increasing the pH of a high-ratio silicate solution may reduce the SiO₂:Na₂O ratio, thereby forming more monomeric silicate species.

In a specific embodiment, pH of the solution may be adjusted so that the degree of polymerization of the alkali metal silicate is less than or equal to about 2.5. In some embodiments, to achieve this degree of polymerization, pH of the solution may be about 11 or higher. In more specific embodiments, pH of the solution may be about 13 or higher.

Alkali metal silicate solutions with a pH-regulated degree of polymerization may be useful as one or more of the following: a builder, a conditioner, an alkaline agent, a filler, a carrier, an antiredeposition agent, a corrosion inhibitor, processing aid (i.e., provides physical characteristics, such as proper pour or flow, viscosity, solubility, stability, and density), and a neutralizing agent. Alkali metal silicate solutions with a pH-regulated degree of polymerization may be included in a cleaning product composition, and when included in such a composition, smaller amounts of active ingredients (or none at all, in some cases) may be used in the cleaning product composition while achieving the same or better cleaning performance. Alkali metal silicate solutions with a pH-regulated degree of polymerization may be capable of softening water and tend not to deposit on the fibers of the cloth being washed. Alkali metal silicate solutions with a pH-regulated degree of polymerization may also have improved builder properties and perform better than or equivalent to phosphate builders. When used in a cleaning product composition, alkali metal silicate solutions with a pH-regulated degree of polymerization may be capable of inhibiting the redeposition of soils, as well as inhibiting the corrosion of metals by, for example, synthetic detergents and complex phosphates. Alkali metal silicate solutions with a pH-regulated degree of polymerization also may supply and maintain alkalinity, which assists cleaning, help keep removed soil from redepositing during washing, and emulsify oily and greasy soils.

The alkali metal silicate solutions with a pH-regulated degree of polymerization of the present disclosure may be made using methods known in the art coupled with pH-regulation. For example, a builder may be made by mixing together two or more natural or partially treated (ground or comminuted) primary raw materials or minerals, in proportions according to the desired SiO₂:Na₂O ratio, raising the mixture to a reacting temperature, such as by introducing the mixture into a furnace, reacting the mixture at the reacting temperature, and forming the builder. One or more of the materials can be in the molten state upon mixing of the other ingredients. The process system for making the material can be batch or continuous. The primary raw materials or minerals contain a source of source of silicon oxide, and a source of disodium oxide. Examples of sources of silicon oxide are silica sand, as well as quartzite and cristobalite. A disodium oxide may be needed to form the various silicate species, and can be obtained from, for example, trona, sodium carbonate, and sodium hydroxide. The raw materials are balanced to provide an alkali metal silicate having a desired or preferred SiO₂:Na₂O ratio or. Other inorganic raw materials useful in laundry and cleaning products may optionally be included in the mixture, such as, for example, phosphorous oxide. The alkali metal silicate may then be placed in solution and its degree of polymerization regulated by adjusting pH.

As mentioned above, the alkali metal silicate solutions with pH-regulated degree of polymerization of the present disclosure may be included in a cleaning product composition. Accordingly, the present disclosure provides, according to another specific example embodiment, cleaning product compositions comprising an alkali metal silicate solution with pH-regulated degree of polymerization and a surfactant. Such cleaning product compositions may be used as, for example, a personal cleaning product, a laundry detergent, a laundry aid, a dishwashing product, and a household cleaner.

Under the appropriate conditions, the alkali metal silicate solutions with pH-regulated degree of polymerization may perform several functions in a cleaning product composition including, but not limited to, water hardness removal, corrosion inhibition, provide alkalinity, carrier, processing aid (i.e., provides physical characteristics, such as proper pour or flow, viscosity, solubility, stability, and density), and antiredeposition. And when included in a cleaning product composition, the solution may, among other things, improve the performance of the cleaning product composition. The solution may be present in the cleaning product composition in a range of between about 3% to about 60% by weight of the cleaning product composition.

Any suitable surfactant may be used in the cleaning product compositions of the present disclosure. Suitable surfactants include, but are not limited to, anionic surfactants (e.g., linear alkylbenzene sulfonate (LAS), alcohol ethoxysulfates, alkyl sulfates, and soap), nonionic surfactants (e.g., alcohol ethoxylates), cationic surfactants (e.g., quaternary ammonium compounds), and amphoteric surfactants (e.g., imidazolines and betaines). The specific surfactant chosen may depend on the application or particular properties desired. For example, anionic surfactants may be chosen when the cleaning product is a laundry or hand dishwashing detergent, household cleaner, or personal cleansing product; nonionic surfactants may be chosen when the cleaning product is a laundry or automatic dishwasher detergent or rinse aid; cationic surfactants may be chosen when the cleaning product is a fabric softener or a fabric-softening laundry detergent; and amphoteric surfactants may be chosen for use when the cleaning product is a personal cleansing product or a household cleaning product.

The cleaning product compositions also may further include other optional components depending on, among other things, a desired application for a cleaning product composition and the desired properties of a cleaning product composition. For example, optional components may be added to provide a variety of functions, such as increasing cleaning performance for specific soils/surfaces, and ensuring product stability. The cleaning product compositions may be in any form, such as, for example, a dry detergent (e.g., a powder) or a liquid detergent (e.g., a gel or a spray). Similarly, the cleaning product compositions may be concentrated, either in a liquid or dry form.

A number of optional components may be included in the cleaning product compositions of the present disclosure. Examples of suitable optional components include, but are not limited to, disinfectants, bleaches, abrasives (e.g. calcite, feldspar, quartz, sand), bluings (i.e., a blue dye or pigment), enzymes (e.g., amylase, lipase, protease, cellulase), fabric softeners, hydrotropes (e.g., cumene sulfonates and ethyl alcohol to inhibit liquid products from separating into layers and/or to ensure product homogeneity), preservatives (e.g., butylated hydroxytoluene, thylene diamine tetraacetic acid, glutaraldehyde), fragrances, processing aids (e.g., clays, polymers, solvents, sodium sulfate), solvents (ethanol, isopropanol, propylene glycol), suds control agents (e.g., alkanolamides, alkylamine oxides, silicones), STPP, zeolites, foam inhibitors, optical brighteners, acids (e.g., acetic acid, citric acid, hydrochloric acid), and alkalis (e.g., ammonium hydroxide, ethanolamines, sodium carbonate, sodium hydroxide).

To the extent any material affects the pH of a cleaning product, other materials may need to be added so that the pH of the cleaning product solution appropriate to regulate the degree of polymerization of the alkali metal silicate as desired.

Alkali metal silicate solutions of the present invention, which may include product made using these solution, such as cleaning products, may be supplied in any variety of forms. For example, they may be dried, a concentrated liquid, or a ready-to-use liquid. If supplied in a dried form, directions for formation of a solution may also be provided and the dried form may be constituted such that when the solution is made as directed, the degree of polymerization of the alkali metal silicate is regulated by pH. As another example, when the alkali metal silicate solution is supplied as a concentrated liquid, the pH of the concentrated liquid may be such that a desired degree of polymerization is present in the concentrated liquid. Alternatively, the concentrated liquid may be supplied with directions for use that include forming a more dilute solution in which pH will regulate the degree of polymerization to a desired level. In still other examples, a concentrated liquid may be formulated such that degree of polymerization is regulated to be a desired level both in the concentrated liquid form and when the liquid is diluted according to directions.

The cleaning product compositions may be formulated using methods known in the art coupled with pH-regulation. For example, solid, dry cleaning product compositions may be formulated using agglomerater techniques or with spray-drying techniques (e.g., using a tower) or both. Such products may be in the form of a hollow particle or a solid particle. The cleaning product compositions also may be formulated as liquid using methods known in the art. Likewise, the cleaning product compositions may in a concentrated or compacted form.

The present disclosure, according to another specific example embodiment, also provides methods of forming cleaning product compositions. Such methods generally comprise combining a surfactant and an alkali metal silicate solution having a pH-regulated degree of polymerization. In one aspect, cleaning product compositions may be formed by providing a surfactant and a polymerized silicate and combining the surfactant and polymerized silicate under pH conditions sufficient to at least partially depolymerize the polymerized silicate, thereby allowing the formation of an alkali metal silicate solution having a pH-regulated degree of polymerization.

To facilitate a better understanding of the present invention, the following examples of specific example embodiments are given. In no way should the following examples be read to limit or define the entire scope of the invention.

### EXAMPLE 1

Several tests were conducted to determine the calcium binding capacity of monomeric and polymeric silicate species as compared to sodium tripolyphosphate (STPP), both as 1% solutions in water. As discussed above, the degree of polymerization is higher in higher SiO₂:Na₂O ratio silicates, and silicates may polymerize at lower pHs. To minimize pH induced polymerization, the pH of the water used to form the 1% solutions was adjusted to about 11.

The results of these tests described above are shown in Table 2.

TABLE 2

| | mg CaCO₃/g | mg CaCO₃/g |
|---|---|---|
| | (water not | (water adjusted |
| 1% solution of: | adjusted) | to pH 11) |
| STPP | 671.76 | |
| SiO₂:Na₂O ratio of 1.00 | 778.86 | 770.64 |
| SiO₂:Na₂O ratio of 1.20 | 666.38 | 710.34 |
| SiO₂:Na₂O ratio of 1.60 | 624.62 | 658.90 |
| SiO₂:Na₂O ratio of 2.35 | 528.23 | 603.43 |
| SiO₂:Na₂O ratio of 3.22 | 395.71 | 581.89 |

As shown in Table 2, lower SiO₂:Na₂O ratios, or monomeric silicate species, have a greater calcium binding capacity. Similarly, when the pH is adjusted to minimize pH induced silicate polymerization, the calcium binding capacity of even high SiO₂:Na₂O ratio silicates increases. The increased pH allows more monomeric species to form, even with high ratio silicates, and also inhibits the further polymerization of silicates with lower degrees of polymerization.

### EXAMPLE 2

The properties of a number of comparative detergent samples were tested to determine pH at 1% solution, solubility, and calcium binding capacity. The comparative test samples included STPP, an alkali metal silicate solution comprising sodium silicate having a SiO₂:Na₂O ratio of 1, model laundry detergents, and a model dishwashing detergent. The comparative test samples are shown in Table 3.

TABLE 3

| Comparative Test | |
|---|---|
| Sample | Composition |
| 1 | granular STPP |
| 2 | ground STPP |
| 3 | alkali metal silicate solution |
| 4 | laundry detergent: 18% LAS, 24% STPP, 6% sodium silicate with a |
| | SiO₂:Na₂O ratio of 2.35; 11% Na₂CO₃, 41% Na₂SO₄ |
| 5 | laundry detergent: 18% LAS, 24% STPP, 7% sodium silicate with a |
| | SiO₂:Na₂O ratio of 2.35; 11% Na₂CO₃, 40% Na₂SO₄ |
| 6 | laundry detergent: 18% LAS, 24% STPP, 7% sodium silicate with a |
| | SiO₂:Na₂O ratio of 2.35; 11% Na₂CO₃, 40% Na₂SO₄ |
| 7 | laundry detergent: 15% LAS, 15% STPP, 7.5% sodium silicate with a |
| | SiO₂:Na₂O ratio of 2.35; 8.5% Na₂CO₃, 54% Na₂SO₄ |
| 8 | laundry detergent: 15% LAS, 12% STPP, 10% sodium silicate with a |
| | SiO₂:Na₂O ratio of 2.35; 9% Na₂CO₃, 54% Na₂SO₄ |
| 9 | laundry detergent: 18% LAS, 12% STPP, 10% sodium silicate with a |
| | SiO₂:Na₂O ratio of 2.35; 0% Na₂CO₃, 55% Na₂SO₄ |
| 10 | laundry detergent: 18% LAS, 24% STPP, 6% sodium silicate with a |
| | SiO₂:Na₂O ratio of 2.35; 0% Na₂CO₃, 55% Na₂SO₄ |
| 11 | dishwashing detergent: 22% LAS, 3% STPP, 10% sodium silicate with |
| | a SiO₂:Na₂O ratio of 2.35; 12% Na₂CO₃, 53% Na₂SO₄ |
| 12 | laundry detergent: 18% LAS, 24% STPP, 6% sodium silicate with a |
| | SiO₂:Na₂O ratio of 2.35; 11% Na₂CO₃, 41% Na₂SO₄ |
| 13 | laundry detergent: 18% LAS, 41% alkali metal silicate solution, 41% |
| | Na₂SO₄ |
| 14 | laundry detergent: 15% LAS, 12% STPP, 10% sodium silicate with a |
| | SiO₂:Na₂O ratio of 2.35; 9% Na₂CO₃, 54% Na₂SO₄ |
| 15 | laundry detergent: 15% LAS, 41% alkali metal silicate solution, 44% |
| | Na₂SO₄ |

A black fabric test was also conducted to measure the deposition of particles on a sample of black fabric. This test is a practical method to approximate what might be seen by the consumer, as particles that deposit on black fabric may look like white lint or powder. The black fabric test was generally carried out as follows. The sample to be tested was mixed and 1.5 grams was weighed out. A 1 liter aliquot of water was equilibrated at the test temperature of about 20° C. The test sample was then added to a Terg-O-Tometer followed by the 1liter aliquot. Next, the sample was agitated for 10 minutes at 50 rpm in the Terg-O-Tometer. At the end of agitation period, the entire contents are poured onto a 90 millimeter Buchner funnel, covered with a black test fabric, such as “C70” available from EMC, and filtered through the black test fabric using standard suction filtration. The Terg-O-Tometer was then rinsed with 500 milliliters of additional water with the same hardness and temperature and poured through the fabric on the Buchner funnel. After filtration, the black fabric was dried at room temperature. The appearance of the fabric was then visually graded on a 1-10 scale, 1 being the worst, i.e., with the most insoluble particles on the fabric, while a grade of 10 is the best.

The results of the tests and a comparison of the samples is shown in Table 4.

TABLE 4

| | | | Calcium binding | | |
|---|---|---|---|---|---|
| Sample | | % moisture | Capacity | Solubility Test | |
| No. | pH | (105° C.) | (mg CaCO₃/g) | Appearance | Black Fabric Test |
| 1 | 9.4 | 6.47 | 671.76 | Clear without insolubles | not tested |
| 2 | 9.7 | 0.38 | 644.94 | Clear without insolubles | not tested |
| 3 | 12.7 | 23.57 | 778.86 | Clear without insolubles | not tested |
| 12 | 10.9 | 8.27 | 318.77 | Turbid insolubles | not tested |
| 13 | 12.3 | 5.69 | 525.56 | Clear without insolubles | 9 |
| 14 | 10.7 | 4.88 | 237.66 | Turbid insolubles | not tested |
| 15 | 12.2 | 5.0 | 543.25 | Clear without insolubles | 10 |
| 15 | 12.3 | 7.69 | 522.37 | Clear without insolubles | 10 |
| 4 | 10.8 | 5.56 | 395.56 | Turbid insolubles | 5 |
| 5 | 10.9 | 5.04 | 341.39 | Turbid insolubles | not tested |
| 6 | 10.7 | 7.38 | 288.94 | Turbid insolubles | not tested |
| 7 | 10.5 | 3.76 | 377.02 | Turbid insolubles | not tested |
| 8 | 10.7 | 5.50 | 258.17 | Turbid insolubles | 4 |
| 9 | 10.6 | 8.04 | 228.22 | Turbid insolubles | not tested |
| 10 | 10.6 | 3.22 | 209.38 | Turbid insolubles | not tested |
| 11 | 10.7 | 3.65 | 110.93 | Turbid insolubles | not tested |

As seen from Table 4, the addition of an alkali metal silicate in solution to a detergent improves the detergent's performance. Detergents formulated with the alkali metal silicate solutions had a higher calcium binding capacity, better solubility, and less undesirable white precipitate on black fabric, as compared to the other detergents tested. As Table 4 shows, examples with a higher pH performed better in the black fabric test, were more likely to be clear without insolubles, and had a higher calcium binding capacity. In addition, detergents formulated using the alkali metal silicate solution required less total material, and therefore may be more cost effective to manufacture.

### EXAMPLE 3

Comparative detergents were formulated using either STPP or an alkali metal silicate solution including sodium silicate having a SiO₂:Na₂O ratio of 1, and the properties of the resulting detergents were compared. The calcium binding capacity of a detergent having STPP and either more surfactant (comparative sample no. 1) or less surfactant (comparative sample no. 3) were compared to comparative example detergents of the present disclosure having the an alkali metal silicate solution and more surfactant (comparative sample no. 2) or less surfactant (comparative sample nos. 4 and 5). The components of the comparative samples are shown in Table 5 and the performances of the comparative samples are shown in Table 6.

In comparative sample nos. 1 and 3, a sodium hydroxide solution was used to neutralize LAS, forming NaLAS. In comparative sample nos. 2 and 5, the alkali metal silicate solution is combined with a sodium hydroxide solution, which is then combined with LAS to form NaLAS. In comparative sample no. 4, a sodium hydroxide solution was used to neutralize LAS, forming NaLAS, then the alkali metal silicate was added. When forming a solution, the order of addition may be significant because if the pH becomes too low, then precipitation may occur. Because of this, in certain embodiments, the silicate may be added to the water.

Table 6 shows that detergents formulated with an alkali metal silicate have a higher calcium binding capacity, are more soluble, and perform better when tested using the black fabric test, as compared to detergents formulated with STPP.

TABLE 5

| | COMPARATIVE | | | | |
|---|---|---|---|---|---|
| DETERGENT | SAMPLE NUMBER | | | | |
| COMPONENTS | 1 | 2 | 3 | 4 | 5 |
| NaLAS (caustic) | 18% | — | 15% | 15% | — |
| NaLAS | — | 18% | — | — | 15% |
| (prototype) | | | | | |
| STPP | 24 | — | 12% | — | — |
| Example | — | 41% | — | 31% | 31% |
| multifunctional | | | | | |
| material | | | | | |
| Sodium Silicate | 6% | — | 10% | — | — |
| (SiO₂:Na₂O ratio of | | | | | |
| 2.35) | | | | | |
| Soda (Na₂CO₃) | 11% | — | 9 | — | — |
| Sodium sulphate | 41% | 41% | 54% | 54% | 54% |
| (Na₂SO₄) | | | | | |

TABLE 6

| | COMPARATIVE SAMPLE NUMBER | | | | |
|---|---|---|---|---|---|
| PERFORMANCE | 1 | 2 | 3 | 4 | 5 |
| Calcium binding | 318.77 | 525.56 | 237.66 | 543.25 | 522.37 |
| Capacity | | | | | |
| (mg CaCO₃/g) | | | | | |
| Black Fabric Test | 5 | 9 | 4 | 9 | 10 |
| Solubility Test & | Slightly | Clear | Turbid | Clear | Clear |
| Appearance | turbid, | without | with | without | without |
| | few | insolubles | insolubles | insolu- | insol- |
| | insolubles | | | ubles | ubles |

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method for regulating the degree of polymerization of an alkali metal silicate in solution comprising:
forming a solution of an alkali metal silicate; and
regulating the pH of the solution to be approximately a selected pH;
wherein the selected pH results in a desired degree of polymerization of the alkali metal silicate in the solution.

2. A method according to claim 1, wherein the solution is an aqueous solution.

3. A method according to claim 1, wherein the alkali metal silicate comprises sodium silicate or potassium silicate.

4. A method according to claim 1, wherein the alkali metal silicate has a SiO₂:Na₂O ratio about 2 or above.

5. A method according to claim 1, wherein the alkali metal silicate has a SiO₂:Na₂O ratio about 1 or above.

6. A method according to claim 1, wherein the selected pH is at least about 11.

7. A method according to claim 1, where the selected pH is at least about 12.

8. A method according to claim 1, wherein the selected pH is at least about 13.

9. A method according to claim 1, further comprising selecting the pH based upon the alkali metal silicate.

10. A method according to claim 1, further comprising selecting the pH based upon the SiO₂:Na₂O ratio of the alkali metal silicate.

11. A method according to claim 1, wherein the desired degree of polymerization is less than or equal to about 2.5.

12. A method according to claim 1, further comprising adding a surfactant to the solution.

13. A method according to claim 12, further comprising adding an optional component to the solution, the optional component selected from the group consisting of a disinfectant, a bleach, an abrasive, a bluing agent, an enzyme, a fabric softener, a hydrotrope, a preservative, a fragrance, a processing aid, a solvent, a suds control agent, STPP, a zeolite, a foam inhibitor, an optical brightener, an acid, a base, ammonium hydroxide, ethanolamines, sodium carbonate, sodium hydroxide, and combinations thereof.

14. A method for making an alkali metal silicate solution comprising:
providing a solution of an alkali metal silicate characterized by a degree of polymerization greater than about 2.5;
adjusting the pH the solution to a level sufficient to at least partially shift the degree of polymerization of the alkali metal silicate to a level less than or equal to about 2.5.

15. A method according to claim 14, wherein the solution is an aqueous solution.

16. A method according to claim 14, wherein the alkali metal silicate has a SiO₂:Na₂O ratio about 2 or above.

17. A method according to claim 14, wherein the alkali metal silicate has a SiO₂:Na₂O ratio about 1 or above.

18. A method according to claim 14, wherein the alkali metal silicate comprises sodium silicate or potassium silicate.

19. A method according to claim 14, wherein the selected pH is at least about 11.

20. A method according to claim 14, where the selected pH is at least about 12.

21. A method according to claim 14, wherein the selected pH is at least about 13.

22. A method according to claim 14, further comprising selecting the pH based upon the alkali metal silicate.

23. A method according to claim 14, further comprising selecting the pH based upon the SiO₂:Na₂O ratio of the alkali metal silicate.

24. A method according to claim 14, further comprising adding a surfactant to the solution.

25. A method according to claim 24, further comprising adding an optional component to the solution, the optional component selected from the group consisting of a disinfectant, a bleach, an abrasive, a bluing agent, an enzyme, a fabric softener, a hydrotrope, a preservative, a fragrance, a processing aid, a solvent, a suds control agent, STPP, a zeolite, a foam inhibitor, an optical brightener, an acid, a base, ammonium hydroxide, ethanolamines, sodium carbonate, sodium hydroxide, and combinations thereof.

26. A method for cleaning comprising contacting a surface with a solution comprising an alkali metal silicate having a degree of polymerization less than or equal to about 2.5, wherein the solution has a pH selected to regulate the degree of polymerization of the alkali metal silicate.

27. A method according to claim 26, wherein the surface is selected from the group consisting of a fabric, a household surface, a textile, a food preparation or service surface, a biological surface, and combinations thereof.
